(19) United States
(12) Patent Application Publication
(10) Pub. No.: US 2003/0187718 A1
(43) Pub. Date: Oct. 2, 2003

(54) Industry information analysis tool

(76) Inventors: Stefan Hack, Wiesloch (DE); Shaun Elliott, Heidelberg (DE)

Correspondence Address: Mark D. Kirkland, Fish & Richardson P.C., 60 South Sixth Street, 3300 Dain Rauscher Plaza, Minneapolis, MN, 55402, US

(21) Appl. No.: 10/161,393

(22) Filed: May 31, 2002

Related U.S. Application Data
(60) Provisional application No. 60/369,020, filed on Mar. 29, 2002.

(51) Int. Cl. G06F 17/60

(52) U.S. Cl. 705/10

(57) ABSTRACT

A strategic management tool that provides industry-specific information. The tool associates each of a plurality of industries with a plurality of market participants, receives a user's selection of an industry, receives a user's selection of a market participant, and provides industry and market participant specific information to a user. The information corresponds to the industry and market participant selected by the user.

### REFERENCE TO RELATED APPLICATION

This application claims priority from U.S. provisional patent application No. 60/369,020, filed on Mar. 29, 2002, entitled “Strategic Opportunity Management Tools and Electronic Business Casebuilder,” which is incorporated herein by reference in its entirety.

### TECHNICAL FIELD

This invention relates to a strategic opportunity management tool, and in particular, to an industry information analysis tool.

### BACKGROUND

An industry is typically comprised of business entities that interact with other business entities. The business entities may include market participants who may use software tools to make decisions regarding how best to interact with other business entities. Each industry may have multiple market participants. An oil and gas industry may have participants that perform tasks in the supply chain including exploration and production, primary distribution, refining and retail sale to the end consumer. A consumer products industry may have participants in the supply chain that perform tasks including component supply, original equipment manufacturing, distributing and retailing. The participants may be acted upon by a variety of market forces and industry trends that may be unique to each participant and may depend on the industry and the participant's role in that industry. For example, a market force such as increased consumer traveling may have a great impact on the oil and gas industry due to a possibility of increased fuel costs than on the consumer products industry. In the consumer products industry, the same increase in fuel costs may have a greater impact on a distributor than on a manufacturer.

A market participant, such as a manufacturer in a consumer products industry, may make business decisions based upon his role in the industry. This decision may also be affected by external factors such as industry trends. For example, consumers may begin to prefer electronic toys to board games. A retailer in the consumer products industry may need to adapt their inventory to meet the change in consumer preferences. However, many of these software tools may lack the ability to assist the market participant in analyzing an industry so as to make effective decisions. For example, the software tool may not include relevant industry information, the information may be of the wrong type, the information may be outdated, or the information may have an inappropriate level of granularity; overwhelming the decision maker. A market participant in an industry may interact with other market participants in the industry or participants from other industries. Each interaction varies in complexity depending on the relationship between the participants and factors affecting the industry.

### SUMMARY OF THE DISCLOSURE

In one aspect, a method is disclosed for providing industry-specific information. The method may associate each of a plurality of industries with a plurality of market participants, receive a user's selection of an industry, receive a user's selection of a market participant, and provide industry- and market participant-specific information to a user. The information may correspond to the industry and market participant selected by the user.

The industry-specific information may be displayed to the user.

A second aspect is an article comprising a computer-readable medium storing computer-executable instructions that when executed by one or more computers causes the computers to perform the method disclosed above.

In a third aspect, a system is provided that includes one or more computers configured to perform the method disclosed above.

In various implementations, the above techniques may provide one or more of the following advantages. The user may select a industry and market participant and be provided with industry and market participant specific information. The industry-specific information may be based on information such as market and/or industry trends. This information may be presented to the user as a single source which may reduce the need for the user to search, gather and analyze information from many different sources. A market participant, such as a manufacturer in the automobile industry, may be provided with market force and market trend information specific to the automobile industry which may help improve the manufacturer's decision-making process.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1A is block diagram of a strategic opportunity management system according to one implementation.

FIG. 1B is process diagram of a strategic opportunity management system according to one implementation.

FIG. 2 is a flowchart showing the operation of various aspects of the strategic opportunity management system according to one implementation.

FIGS. 3A-3D depict output from a strategic opportunity management system according to one implementation.

Like reference symbols in the various drawings indicate like elements.

### DETAILED DESCRIPTION OF ILLUSTRATIVE EMBODIMENTS

FIG. 11A is a block diagram of a strategic opportunity management system 10. The system 10 includes one or more host servers 12 that includes a strategic management engine 14 that may be accessed by user using computer devices 16a, 16b, . . . 16n over a network 18. The strategic management engine 14 includes an industry analysis engine 21, an opportunity assessment engine 22, and a value calculation engine 23. In certain embodiments, the system 10 provides information to assist a user in analyzing a strategic opportunity. Such information may include, for example, industry data relevant to a customer, a list of business scenarios relevant to the user, proposed business strategies and objectives, proposed products and services that meet the business strategies and objectives, and a high level calculation of the value (e.g., return on investment) that may be provided by implementation of the products and services that meet the identified business strategies and objectives.

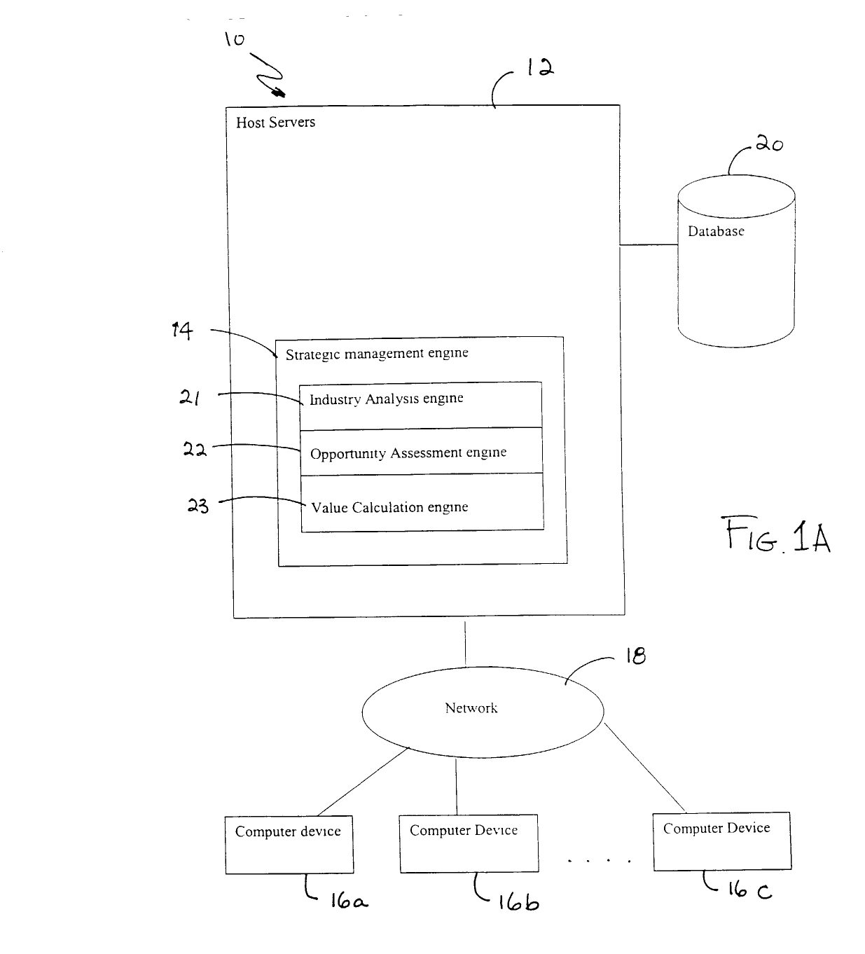

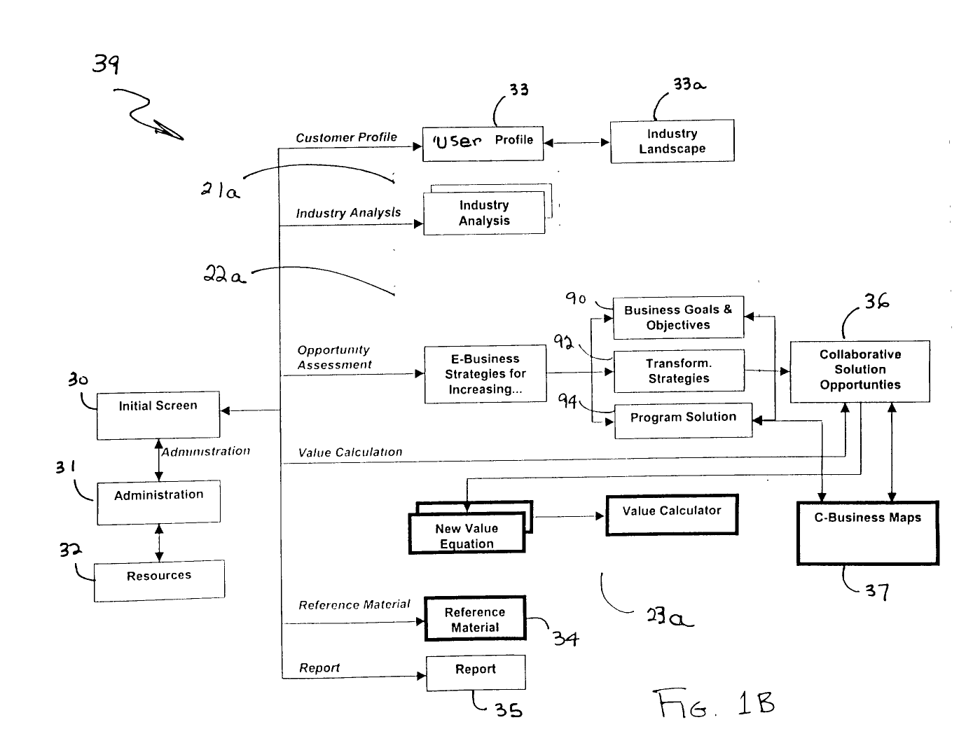

The host servers 12 of FIG 1A may include, for example, an Internet-accessible server. The strategic management engine 14 may be distributed and executed on one or more host servers 12. A database 20 may be used by the host servers 12 to store and retrieve information related to the operation of the host servers 12 including the execution of the strategic management engine 14. The network 18 may include a plurality of devices such as servers, routers and switching circuits connected in an intranet, extranet or Internet configuration.

A user may use a computer device, such as computer device 16a, to access the host servers 12 over a network 18. The computer device 16a may include a personal computer (PC), personal digital assistant (PDA) or other device using wireless or wired communication protocols to access the host servers 12. The computer device 16a may be coupled to I/O devices (not shown) that may include a keyboard in combination with a pointing device such as a mouse to input data into the computer, a computer display screen and/or a printer to produce output from the computer, a storage resource such as a hard disk drive for storing and retrieving data for the computer, and/or other I/O devices.

FIG. 1B is a process diagram of an implementation of a strategic opportunity management system 10. Processes 39 may be implemented using a graphical user interface. The processes 39 may include an “initial” display 30 of information related to the system 10 such as a description of the purpose and the output of the system. A “user profile” 33 may allow the user to enter information related to the industry that is of interest to the user. This information may be used to identify an industry from an industry landscape that may include a plurality of industries. For example, a user in the consumer products industry may desire to select information related to that industry from among a plurality of industries. “Administration” 31 may be provided to manage a user's profile including providing a “create” area that allows the user to create a new user profile and a “view/edit” area that allows the user to view or edit a previously created user profile. User profile information includes information provided by the user which may be used during the operation of the strategic management engine 14. However, to gain access to the system 10, the “administration” 31 may require the user to provide uniquely identifiable information such as a company name and/or a profile identifier. The identifiable information provided by the user may be compared with user information previously stored in the host servers 12 to determine whether the user currently attempting to access the system 10 is authorized to access the system. “Resources” 32 may provide links and Email addresses for business case resources such as business case systems, competitive information, business case development and consulting, sales support, evaluation and design tools, public information, or other resources.

If the user is authorized to access the system 10, the user may select the “industry analysis” 21a function from the processes 39. This engine, in certain embodiments, may help the user identify an industry sector from a predetermined industry landscape that includes a plurality of industry sectors. Examples of industry sectors include consumer products, utilities, chemicals, oil and gas, and the like. The “industry analysis” 21a also may provide or conduct, in selected implementations, an industry analysis. The industry analysis may include defining participants in terms of their function or role. For example, in the consumer products sector, the participants may include a manufacturer, supplier, retailer, intermediate manufacturer, distributor, and the like. The industry analysis may also identify market forces associated with the selected industry sector for each role. In an illustrative embodiment, trends related to a manufacturer may include tight labor markets, shift toward a retail demand focus, and rapidly shifting consumer preferences. Details concerning certain of the identified market factors may also be displayed. The system may optionally also display solutions/responses to certain of the identified market factors (e.g., one-to-one customer interaction in response to tight labor market). The system may also identify industry trends being pursued by other firms in the selected industry sector(s). The industry analysis may also provide case examples. The information and/or analysis may be derived from databases and other such sources.

An “opportunity assessment” 22a function, in certain embodiments, may assess and generate data concerning one or more opportunities, or may provide proposed business strategies suitable for the selected industry sector. For example, a manufacturer in an consumer products industry may be able to analyze data related to changes in consumer demand. Opportunities may A user may select role or participant functionality. For instance, in the consumer products industry sector, the participants may include a manufacturer, distributor, retailer, and the like. The system may also be configured to permit the user to select a business maturity for various facets of the participant entity, such as strategy, infrastructure, technology, and business culture. “Business maturity” is that period during which an enterprise seeks to secure market position, optimize investment opportunities, and explore product and market diversification. The “opportunity assessment” 22a section may allow identification of value-added business processes and/or strategies. For example, some versions may feature three ways to identify business strategies. The first presents transformation strategies 92. The second identifies proposed business goals and strategies 90. The third presents various solution areas that logically group various strategies 94.

In the first method 92 of identifying value-added strategies, transformation strategies are defined and presented along with proposed complementary strategies that will produce a shortlist of relevant and value-adding business strategies for the user. The user may select for further analysis one or more strategies from a list of strategies recommended by the system. For example, a user, such as a manufacturer in a consumer products industry, may select for further analysis the transformational strategy “customer self-service.” In response, the system may provide and/or describe “complementary business strategies” such as “one-to-one customer interaction” or customer life-cycle management. By reviewing the transformational strategies, the customer may identify which method or methods are most appropriate for their business.

In the second method 90, business objectives are presented with a list of possible specific plans to accomplish those objectives A user may select one or more of the plans for further analysis. For example, a user, such as a manufacturer in a consumer products industry, may select a Business Goal such as “reducing operating costs” or “lowering working capital.” For each goal, the system may provide one or more business objectives such as “reduce inventory levels” or “improve procurement processes” to achieve the selected goal. This method of producing a shortlist of relevant and value-adding business processes may require more detailed user input that the transformational strategies method, and may be more suitable for a business unit operational head.

The third method 94 of identifying value-added business strategies presents various solution areas that logically group various strategies. A user may select a group of strategies based on problem statements or questions associated with a strategy group. For example, a “customer relationship management” group of strategies may offer the problem statement “Are your high-value customers getting the service they deserve?” The system may display a list of business scenarios (e.g., collaborative sales processes, key account management). After reviewing the aforementioned information, the user may rank the relative importance of each business scenario. The rankings of the importance of the business scenarios may help to define a set of strategies. This method may be more targeted than the other two methods, and may be more suitable for the tactical business processes appropriate for functional managers.

The results of “opportunity assessment” 22a may be provided to “collaborative solution opportunities” 36 function and “C-business maps” (Collaborative Business Maps) 37 function. The “C-business maps” 37 function refers to a method of viewing and modeling business scenarios using program solutions. It provides a visual representation of business processes and typical employee roles and presents the benefits and potential value that may be achieved by using these solutions. The “collaborative solution opportunities” 36 function may identify information technology (IT) tasks required to implement the solutions and determine an array of potential implementations to facilitate those tasks. See, for example, U.S. provisional patent application No. 60/369,020, filed on Mar. 29, 2002, entitled “Strategic Opportunity Management Tools and Electronic Business Casebuilder.”

A “value calculation” 23a function may calculate the value of the strategies selected by the user (such selection may occur in the foregoing steps in certain embodiments). The system may identify software products and related services that may be used to implement or facilitate the strategies identified in the previous steps. The value calculation may be based on customer-provided input regarding potential value or savings. For instance, the user may input cost advantages (e.g., potential procurement cost reduction), revenue growth opportunities (e.g., improved order fill rate), and intangible benefits (e.g., goodwill). The system then generates a report that may identify business concerns such as return on investment, payback period, and/or net present value associated with the proposed solution(s).

“Reference material” 34 may be used to maintain links to reference material that might be of interest to a particular user. For example, the material may include presentations, spreadsheets, information regarding Websites, or other material. An output report for the user that may include information from the above functions or screens may be generated at “report” 35. The format of the report may be a soft copy, such as a printed version, a hard copy such as an electronic file in the host server 12, or other format that may be in machine or human readable format.

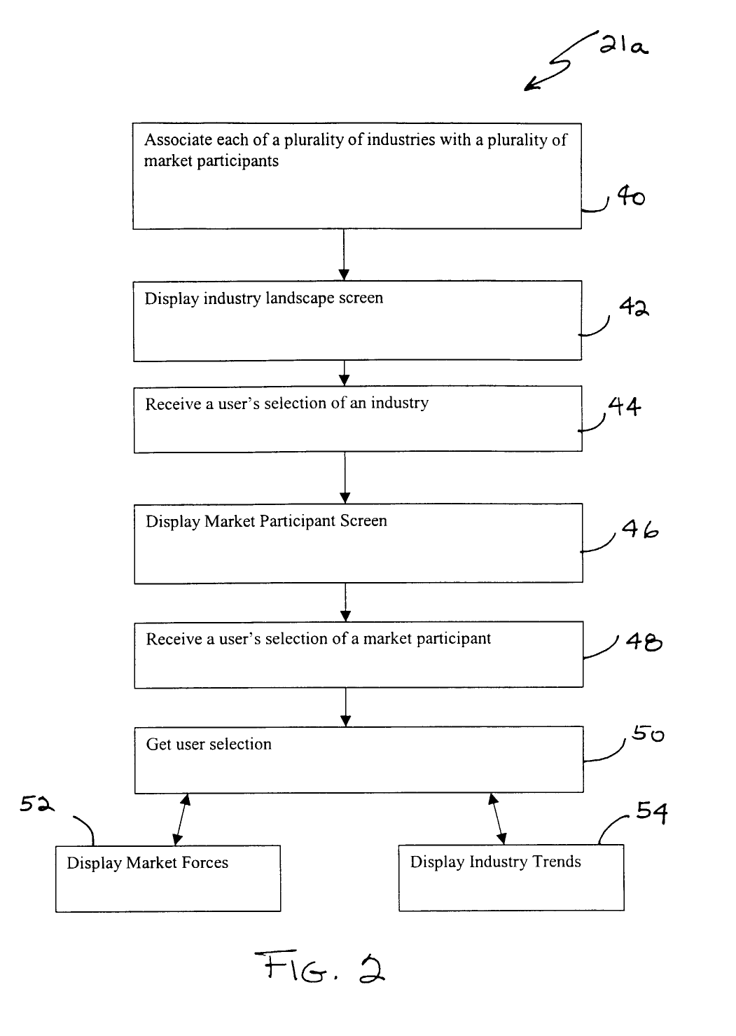

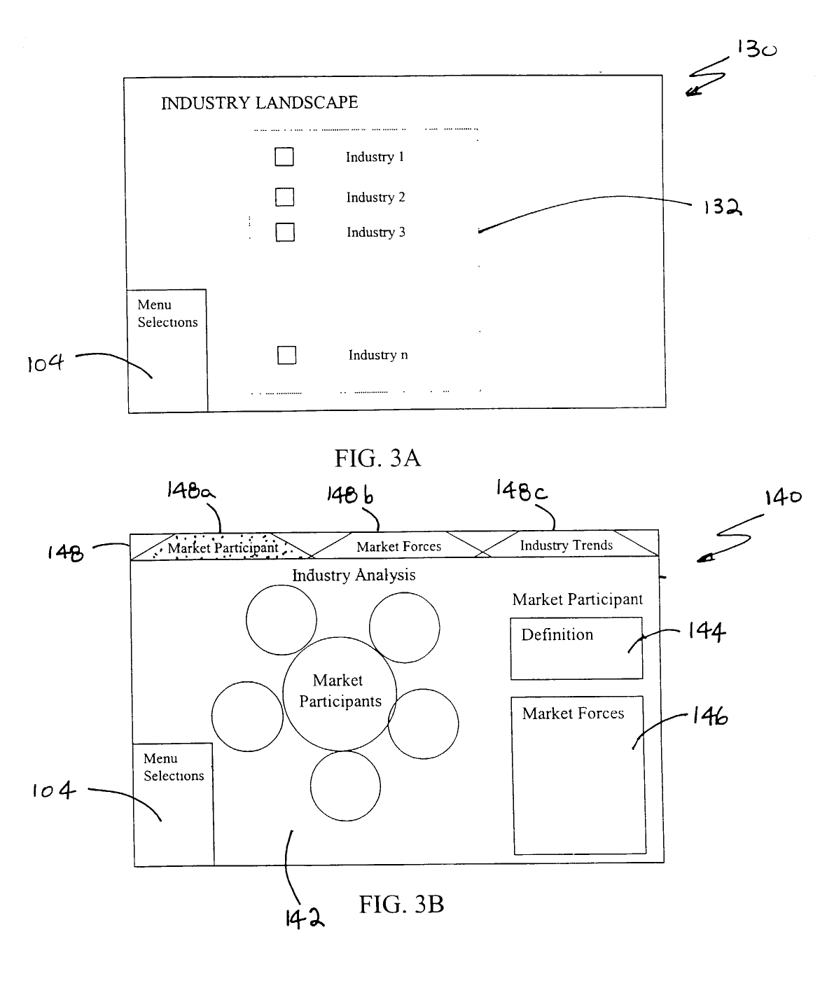

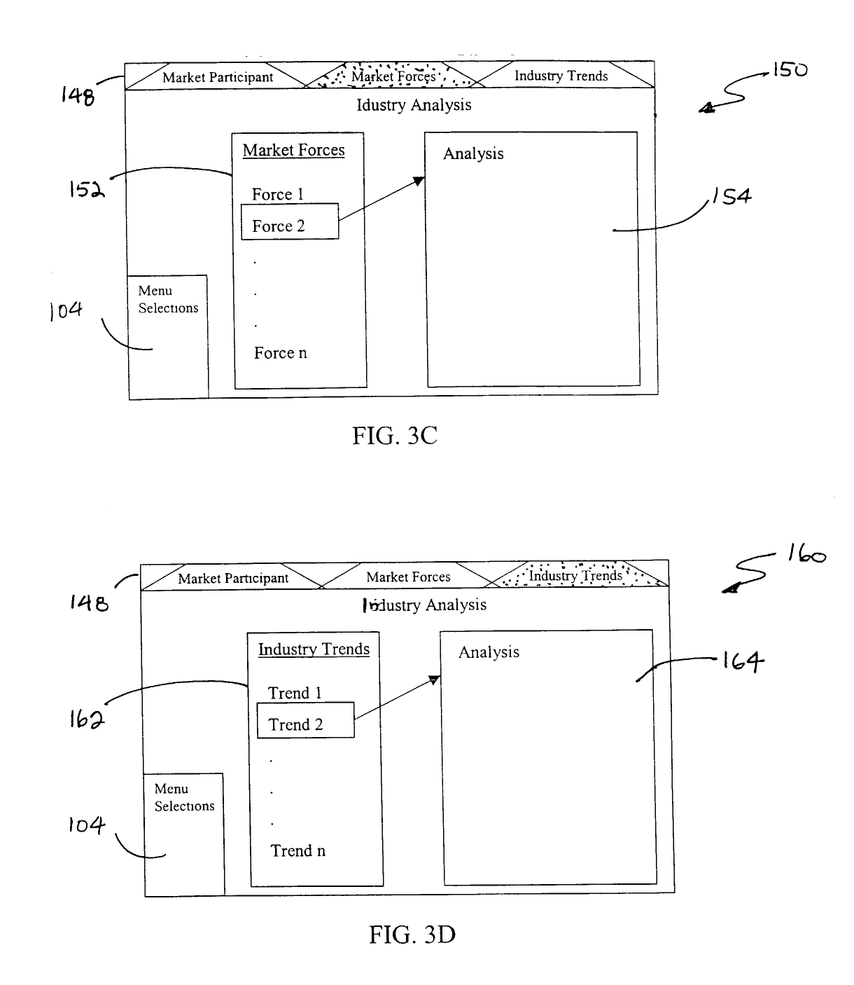

FIG. 2 is a flow chart showing the operation of the industry analysis 21a portion of the processes 39 in FIG. 1B. A user, such as a market participant, may use a computer device such as 16a of FIG. 1A to access the host servers 12. The user typically utilizes a personal computer (PC) to access the industry analysis 21a. The industry analysis may associate 40 each of a plurality of industries with a plurality of market participants. Referring to FIG. 3A, the industry analysis may produce 42 an “industry landscape” screen 130 which may include an “option” menu 104. The “option” menu 104 may include selectable options that enables the user to navigate through the different screens or functions of the system 10.

Referring again to FIG. 2, the industry analysis receives 44 a user's selection for an industry. For example, the user may be interested in the “consumer products” industry, so the user may select a “consumer products” icon. As a result, the system 10 may display 44 a “market participant” screen 140 associated with the selected industry. (See FIG. 3B) The “market participant” screen 140 may display market participant icons 142 representing market participants that may be involved in the consumer products industry.

Referring again to FIG. 2, the industry analysis receives 48 a user's selection for a market participant. For example, the user may select a particular market participant icon 142 that is of interest to the user. A “description” area 144 may be provided to describe the role of the selected market participant. Likewise, a “market forces” area 146 may provide a description of market forces that may be associated with the selected market participant 142 in the industry. The user may select another industry and/or another market participant within the industry by returning to the “industry analysis” screen. This may be accomplished by clicking on a “industry analysis” function of the “option” menu 104.

Referring again to FIG. 2, the industry analysis may provide industry and market participant specific information to a user. The information corresponds to the industry and market participant selected by the user. The user can select 50 industry-specific information such as market forces and industry trends associated with an industry. The “market participant” screen 140 (FIG. 3B) may provide a set of selectable tabs 148 including a “market participant” tab 148a, a “market forces” tab 148b, and a “industry trends” tab 148c.

The industry analysis displays 52 a “market forces” screen 150 as a result of the user selecting the “market forces” tab 148b. (See FIG. 3C) The “market forces” screen 150 provides a list 152 of key market forces that may have an impact on the selected industry. For each highlighted market force in the list 152, an information area 154 may be provided to supply additional information related to the market force. An example of additional information may include a “What does it mean to you?” section to describe the importance of the market force, a “ramification” section to describe the impact the market force may have on the industry, an “Internet impact” section to describe the impact the Internet may have on the industry, a “case examples” section to provide examples from industry and business journals, and a “proposed strategies” section that is a list of proposed strategies, such as transformational strategies, that may be relevant to the market force. The information displayed in the “market forces” screen 150 may be stored in one or more databases and refreshed periodically such as quarterly.

In a similar manner, the industry analysis displays 54 the “industry trends” screen 160 as a result of the user selecting the “industry trends” tab 148c. (See FIG. 3D) The “industry trends” screen 160 may provide a list 162 of key industry trends being pursued by other firms within the selected industry. These displayed trends may be important to these firms because they may be used to either overcome negative market forces or to leverage positive influences. For each highlighted market trend in the list 162, an information area 164 may be provided for additional information related to the market trend. For example, a description section may provide a description of the highlighted market trend and a “case examples” section may provide case examples based on information from industry and business journals. The information in the “industry trends” screen 160, like the information in the “market forces” screen 150, may be refreshed periodically such as quarterly.

Those skilled in the art will appreciate from the foregoing description that the methods and apparatus identified herein may be advantageously modified in an almost limitless number of ways. For instance, one or more of the foregoing techniques may be advantageously performed in isolation or in any desired combination or order. The software may be configured to be executed on any variety of platforms, such as intranets, wireless networks, and local hard disks by way of non-limiting example. The software may be executed on one or more computers, host servers or distributed host servers. The systems and techniques described herein may be implemented in environments without software, including as “paper and pencil” versions. Any amount of proprietary content may be incorporated into this system, such as propriety business models, industry trends, and market forces. Any aspect of the business strategy evaluation, value calculations, etc. may be implemented at a finer granularity by use of more detailed information, models, inputs and/or algorithms, for example. None of the particular techniques need be performed in the order indicated unless specifically stated. To the contrary, the techniques may be freely modified by substituting and/or reordering steps as suitable for particular implementations. Any output from the system described herein may be presented in any manner suitable for a particular user, and may include any aspect of the business strategies, industry trends, and market forces described herein.

As an example, it is not necessary to display an industry landscape screen to receive a user's selection of an industry. The landscape could, for example, be provided alternatively in a book or manual. Also, the industry may be pre-selected. Similarly, it is not necessary that a market participant screen be displayed. The user may select a market participant through alternative means such as from a chart.

Various features of the system may be implemented in hardware, software, or a combination of hardware and software. For example, some aspects of the system may be implemented in computer programs executing on programmable computers. Each program may be implemented in a high level procedural or object-oriented programming language to communicate with a host servers.

Furthermore, each such computer program may be stored on a storage medium, such as read-only-memory (ROM), readable by a general or special purpose programmable computer, for configuring and operating the computer when the storage medium is read by the computer to perform the functions described above.

Other implementations are within the scope of the following claims.

What is claimed is:

1. A method of providing industry-specific information comprising:
providing information that associates each of a plurality of industries with a plurality of market participants and further associates at least one of market force or industry trend information to market participants;
receiving a user's selection of an industry;
receiving a user's selection of a market participant; and
providing industry-specific and market participant-specific information to a user, said information corresponding to the industry and market participant selected by the user and including at least one of market force or industry trend information.

2. The method of claim 1 further comprising displaying the industry-specific information.

3. The method of claim 1 further comprising prompting the user to select an industry.

4. The method of claim 3 further comprising prompting the user to select a market participant.

5. The method of claim 1 wherein both the market force and industry trend are provided.

6. The method of claim 3 further comprising transmitting data to permit the display of an industry selection screen to the user.

7. The method of claim 4 further comprising transmitting data to permit the display of a market participant selection screen to the user.

8. The method of claim 1 wherein each market participant has market force and industry trend information associated therewith.

9. The method of claim 1 wherein the information that associates each of a plurality of industries with a plurality of market participants is retrieved from an electronic database.

10. An article comprising a computer-readable medium storing computer-executable instructions that when applied to one or more computers cause the computers to:
provide information that associates each of a plurality of industries with a plurality of market participants and further associates at least one of market force or industry trend information to market participants;
receives a user's selection of an industry;
receives a user's selection of a market participant; and
provides industry-specific and market participant-specific information to a user, said information corresponding to the industry and market participant selected by the user and including at least one of market force or industry trend information.

11. The article of claim 10 further comprising instructions that when applied to the computer cause the computers to display the industry-specific information.

12. A system for providing industry-specific information, the system comprising one or more computers configured to:
provide information that associates each of a plurality of industries with a plurality of market participants and further associates at least one of market force or industry trend information to market participants;
receives a user's selection of an industry;
receives a user's selection of a market participant; and
provides industry-specific and market participant-specific information to a user, said information corresponding to the industry and market participant selected by the user and including at least one of market force or industry trend information.

13 The system of claim 12 the one or more computers further configured to display industry-specific information.
